(19) United States
(12) Patent Application Publication
(10) Pub. No.: US 2022/0386692 A1
(43) Pub. Date: Dec. 8, 2022

(54) CARTRIDGE WITH CONDUCTION AND CONVECTION HEATING

(71) Applicant: Jupiter Research, LLC, Phoenix, AZ (US)

(72) Inventors: San Li, Chandler, AZ (US); Jordan Walker, Phoenix, AZ (US); Mark Scatterday, Scottsdale, AZ (US)

(21) Appl. No.: 17/698,231

(22) Filed: Mar. 18, 2022

Related U.S. Application Data
(60) Provisional application No. 63/196,598, filed on Jun. 3, 2021.

(51) Int. Cl. A24F 40/44; A24F 40/10; A24F 40/42; A24F 40/46; H05B 3/26

(52) U.S. Cl. CPC A24F 40/44; A24F 40/10; A24F 40/42; A24F 40/46; H05B 3/26

(57) ABSTRACT

Various embodiments of the subject technology may provide methods and apparatus for using a cartridge to vaporize a vaporizable liquid. The methods and apparatus for using the cartridge to vaporize the vaporizable liquid may include drawing air into an airflow path of the cartridge. The methods and apparatus for using the cartridge to vaporize the vaporizable liquid may also include vaporizing a first portion of the vaporizable liquid by conductively heating the first portion as the air is drawn into the airflow path. The methods and apparatus for using the cartridge to vaporize the vaporizable liquid may further include vaporizing a second portion of the vaporizable liquid by convectively heating the second portion as the air flows along the airflow path.

### CROSS-REFERENCE TO RELATED APPLICATION

This application claims the benefit of U.S. Provisional Patent Application Ser. No. 63/196,598, filed on Jun. 3, 2021, and incorporates the disclosure of the application in its entirety by reference.

### BACKGROUND OF THE TECHNOLOGY

### State of the Art

Vaporizer devices present an alternative to smoking and work by vaporizing a consumable vaporizable liquid, e.g., oil or extract, by heating the vaporizable liquid at a lower temperature than an open flame so that a user can inhale the vaporizable liquid in vapor form, rather than smoke.

A conventional cartridge of a vaporizer device typically has a reservoir for holding the vaporizable liquid, a wick capable of soaking up the vaporizable liquid, and a heated coil in contact with the wick. A current is typically passed through the coil, heating the wick, and vaporizing the vaporizable liquid. However, a conventional cartridge typically heats the vaporizable liquid at a single temperature or within a narrow temperature range. Because different vaporizable liquids have different chemical and physical properties, e.g., vapor pressure, that are optimized at different temperatures, a conventional cartridge does not make the most effective use of chemical and physical properties that are optimized outside of the narrow temperature range. In this regard, a conventional cartridge is prone to producing low-quality vapor and inconsistent flavor profiles.

Accordingly, what is needed is a cartridge that vaporizes a vaporizable liquid in a wide temperature range so that a user can be provided with high-quality vapor, consistent flavor profiles, and improved sensory experiences over the lifetime of the cartridge.

### SUMMARY OF THE TECHNOLOGY

Various embodiments of the subject technology may provide methods and apparatus for using a cartridge to vaporize a vaporizable liquid. The methods and apparatus for using the cartridge to vaporize the vaporizable liquid may comprise drawing air into an airflow path of the cartridge. The methods and apparatus for using the cartridge to vaporize the vaporizable liquid may also comprise vaporizing a first portion of the vaporizable liquid by conductively heating the first portion as the air is drawn into the airflow path. The methods and apparatus for using the cartridge to vaporize the vaporizable liquid may further comprise vaporizing a second portion of the vaporizable liquid by convectively heating the second portion as the air flows along the airflow path.

### BRIEF DESCRIPTION OF THE DRAWINGS

A more complete understanding of the subject technology may be derived by referring to the detailed description and claims when considered in connection with the following illustrative figures. In the following figures, like reference numbers refer to similar elements and steps throughout the figures.

FIG. 1 is a sectional view of a cartridge in accordance with a first embodiment of the subject technology;

FIG. 2 is a sectional view of a cartridge in accordance with a second embodiment of the subject technology; and

FIG. 3 is a flow chart for using a cartridge to vaporize a vaporizable liquid in accordance with an embodiment of the subject technology.

### DETAILED DESCRIPTION OF EMBODIMENTS

The subject technology may be described in terms of functional block components. Such functional blocks may be realized by any number of components configured to perform the specified functions and achieve the various results. For example, the subject technology may employ various bodies, heating elements, inlets, outlets, porous bodies, wicks, reservoirs, vaporizable liquids, extracts, oils, and the like, which may carry out a variety of functions. In addition, the subject technology may be practiced in conjunction with any one of various vaporizer devices, and the cartridge described herein is merely one exemplary application for the technology.

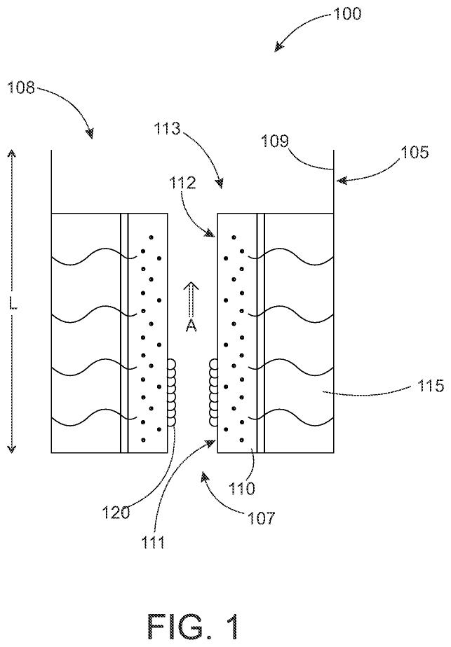

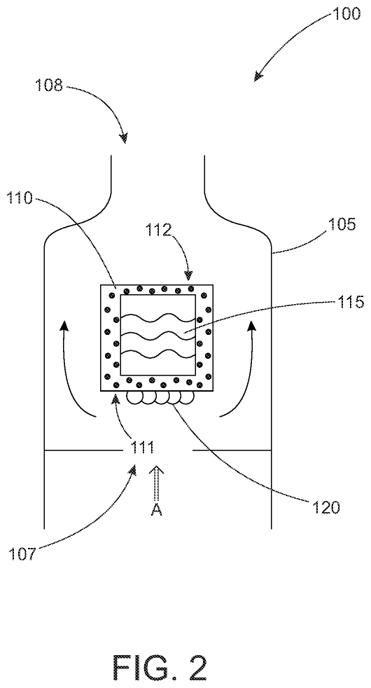

Referring to FIGS. 1-2, an exemplary cartridge 100 may be integrated in any suitable vaporizer device (not shown) for vaporizing a vaporizable liquid. In various applications, the cartridge 100 may operate to make the most effective use of various chemical and physical properties of the vaporizable liquid by forming a temperature gradient within the cartridge 100 so that a user can be provided with high-quality vapor, consistent flavor profiles, and improved sensory experiences over the lifetime of the cartridge 100. According to various embodiments, the cartridge 100 may comprise a body portion 105, a porous body 110, a reservoir 115, and a heating element 120.

In various embodiments, the body portion 105 may comprise an inlet 107 and an outlet 108 opposite the inlet 107. The body portion 105 may also comprise an airflow path A that extends through the body portion 105 from the inlet 107 to the outlet 108. In some embodiments, the body portion 105 may further comprise an interior surface 109 defining a receptacle cavity 113 for housing the porous body 110 and the reservoir 115. The interior surface 109 may be configured to receivably engage the reservoir 115, and the porous body 110 may be positioned adjacent to the reservoir 115. The porous body 110 and the reservoir 115 may each extend along a longitudinal length L of the body portion 105.

The porous body 110 may be configured to wick the vaporizable liquid from the reservoir 115. In various embodiments, the porous body 110 may comprise a lower portion 111 proximate the inlet 107 and an upper portion 112 proximate the outlet 108. In one embodiment, the porous body 110 may be disposed within the body portion 105 of the cartridge 100, such as shown in FIG. 1.

In an alternative embodiment, the porous body 110 may be disposed within the airflow path A of the body portion 105, such as shown in FIG. 2. In this embodiment, the porous body 110 may comprise a block-shaped body. The porous body 110 may, however, comprise any suitable size or shape. In addition, the porous body 110 may be constructed from any suitable porous material, such as ceramic, cellulose, cotton, silica, or a combination thereof.

The reservoir 115 may comprise any suitable reservoir or tank capable of holding the vaporizable liquid therein. The reservoir 115 may be in fluid communication with the porous body 110, such that the vaporizable liquid may flow from the reservoir 115 to the porous body 110. The reservoir 115 may comprise any suitable size and shape. For example, in one embodiment, the reservoir 115 may be cylindrical-shaped and may be configured to hold up to 5 or 6 ml of the vaporizer liquid. In addition, the reservoir 115 may be constructed from any suitable material, such as glass, plastic, and the like.

The heating element 120 may be configured to apply heat to the porous body 110, such that the porous body 110 may be heated to a temperature sufficient to vaporize the vaporizable liquid wicked thereinto. In one embodiment, the heating element 120 may be coupled to the lower portion 111 of the porous body 110. Specifically, the heating element 120 may be directly connected to the porous body 110. The heating element 120 may comprise any suitable resistive element that dissipates heat when an electric current flows through it, such as a coil, ribbon, strip of wire, wire mesh, and the like. It will be appreciated that the heating element 120 may be constructed from a variety of suitable materials, such as copper, nickel, iron, stainless steel, or a combination thereof.

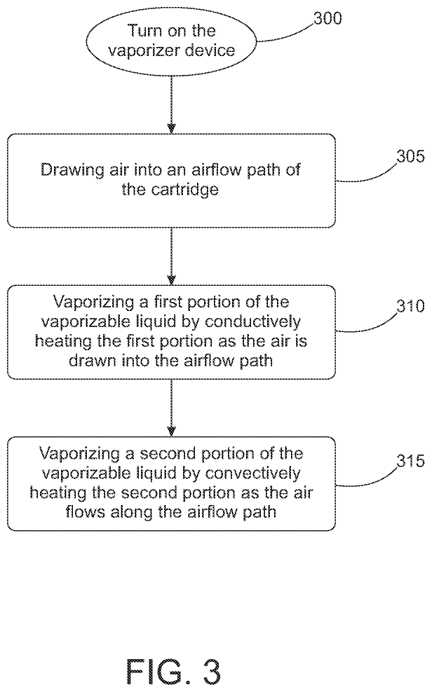

In operation, and referring now to FIGS. 1-3, vaporizing the vaporizable liquid may comprise turning on the vaporizer device (300). The vaporizer device may be turned on by a sensor (not shown) or by pressing a button or switch. Vaporizing the vaporizable liquid may also comprise drawing air into the airflow path A of the cartridge 100 (305). As an example, in the case where the vaporizer device is “draw-activated,” a user may turn on the vaporizer device by drawing air into the vaporizer device via the inlet 107 by inhaling through a mouthpiece (not shown) connected to the outlet 108. When the user inhales, a negative pressure may be induced inside the vaporizer device. The negative pressure induced inside the vaporizer device may cause the sensor to close a pressure switch (not shown), thereby closing a circuit between a battery (not shown) and the various components of the vaporizer device. Once the pressure switch (not shown) is closed, the battery may supply power to the various components of the vaporizer device, including the heating element 120.

Vaporizing the vaporizable liquid may further comprise vaporizing a first portion of the vaporizable liquid that is wicked into a lower portion 111 of the porous body 110 proximate the inlet 107 (310). Because the heating element 120 may be directly connected to the lower portion 111 of the porous body 110, the heating element 120 may be utilized to apply heat directly to the lower portion 111. Accordingly, the heating element 120 may be utilized to conductively heat the first portion of the vaporizable liquid as the air is drawn into the airflow path A. Applying heat to the lower portion 111 of the porous body 110 may form a hot vapor as air is drawn into the airflow path A of the cartridge 100. Once the hot vapor is produced, it may mix with the air drawn into the cartridge 100 via the inlet 107, and the resulting (hot vapor and airflow) may travel as a stream upwards along the airflow path A.

Vaporizing the vaporizable liquid may further comprise vaporizing a second portion of the vaporizable liquid that is wicked into an upper portion 112 of the porous body 110 proximate the outlet 108 (315). As the resulting (hot vapor and airflow) flows as a stream upwards along the airflow path A, the resulting (hot vapor and airflow) may convectively heat the second portion of the vaporizable liquid that is wicked into the upper portion 112 of the porous body 110. Once the second portion of the vaporizable liquid is convectively heated, it may mix with the hot vapor and air and travel as a stream along the airflow path A where it may be expelled via the outlet 108 and inhaled through the mouthpiece.

Because the temperature of the combined hot vapor and air may drop as the combined hot vapor and air flows toward the outlet 108, a temperature gradient may be formed along the longitudinal length L of the body portion 105 and between the inlet 107 and the outlet 108. The resulting temperature gradient may comprise any suitable temperature range so long as the temperature range is wide enough to make the most effective use of various chemical and physical properties of different vaporizable liquids. For example, the temperature gradient may be between about 80 degrees Celsius and about 220 degrees Celsius. In this regard, the cartridge 100 along with the resulting temperature gradient may operate to make the most effective use of a wide variety of chemical and physical properties, thereby providing a user with high-quality vapor and consistent flavor profiles over the lifetime of the cartridge 100.

In the foregoing specification, the technology has been described with reference to specific embodiments. Various modifications and changes may be made, however, without departing from the scope of the subject technology as set forth in the claims. The specification and figures are illustrative, rather than restrictive, and modifications are intended to be included within the scope of the subject technology. Accordingly, the scope of the technology should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims. Benefits, other advantages, and solutions to problems have been described above with regard to particular embodiments; however, any benefit, advantage, solution to problem or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes,” or any variation thereof, are intended to reference a non-exclusive inclusion, such that a process, method, article, composition, or apparatus that comprises a list of elements does not include only those elements recited but may also include other elements not expressly listed or inherent to such process, method, article, composition, or apparatus. Other combinations and/or modifications of the above-described structures, arrangements, applications, proportions, elements, materials, or components used in the practice of the subject technology, in addition to those not specifically recited, may be varied, or otherwise particularly adapted to specific environments, manufacturing specifications, design parameters or other operating requirements without departing from the general principles of the same.

1. A cartridge for use with a vaporizer device, comprising:
a body portion comprising an airflow path, an inlet, and an outlet;
a porous body configured to wick a vaporizable liquid;
a reservoir in fluid communication with the porous body; and
a heating element configured to apply heat to the porous body, wherein:
a first portion of the vaporizable liquid wicked into the porous body is conductively heated; and
a second portion of the vaporizable liquid wicked into the porous body is convectively heated.

2. The cartridge of claim 1, wherein the porous body comprises ceramic, cellulose, cotton, silica, or a combination thereof.

3. The cartridge of claim 1, wherein the porous body, reservoir, and heating element are each disposed within the airflow path of the body portion.

4. The cartridge of claim 1, wherein:
the body portion further comprises an interior surface defining a receptacle cavity in the body portion;
the interior surface is configured to receivably engage the reservoir;
the porous body is positioned adjacent to the reservoir; and
the porous body and the reservoir each extend along a longitudinal length of the body portion.

5. The cartridge of claim 1, wherein:
the first portion of the vaporizable liquid is wicked into a lower portion of the porous body proximate the inlet; and
the second portion of the vaporizable liquid is wicked into an upper portion of the porous body proximate the outlet.

6. The cartridge of claim 5, wherein the heating element is directly connected to the lower portion of the porous body and is configured to apply heat to the lower portion to form a vapor.

7. The cartridge of claim 6, wherein the second portion of the vaporizable liquid is convectively heated by the vapor.

8. The cartridge of claim 7, wherein a temperature gradient is formed along a longitudinal length of the body portion and between the inlet and the outlet.

9. The cartridge of claim 8, wherein the temperature gradient is between about 80 degrees Celsius and about 220 degrees Celsius.

10. A method of using a cartridge to vaporize a vaporizable liquid, comprising:
drawing air into an airflow path of the cartridge;
vaporizing a first portion of the vaporizable liquid by conductively heating the first portion as the air is drawn into the airflow path; and
vaporizing a second portion of the vaporizable liquid by convectively heating the second portion as the air flows along the airflow path.

11. The method of claim 10, wherein:
the first portion of the vaporizable liquid is wicked into a lower portion of a porous body proximate an inlet of the cartridge; and
the second portion of the vaporizable liquid is wicked into an upper portion of the porous body proximate an outlet of the cartridge.

12. The method of claim 11, wherein the porous body comprises ceramic, cellulose, cotton, silica, or a combination thereof.

13. The method of claim 11, wherein conductively heating the first portion of the vaporizable liquid comprises utilizing a heating element of the cartridge to apply heat directly to the lower portion of the porous body to form a vapor.

14. The method of claim 13, wherein convectively heating the second portion of the vaporizable liquid comprises utilizing the vapor to convectively heat the second portion.

15. The method of claim 14, wherein a temperature gradient is formed along a longitudinal length of the body portion and between the inlet and the outlet.

16. The method of claim 15, wherein the temperature gradient is between about 80 degrees Celsius and about 220 degrees Celsius.
